(19) United States
(12) Patent Application Publication
(10) Pub. No.: US 2006/0252375 A1
(43) Pub. Date: Nov. 9, 2006

(54) Probing system for integrated circuit devices

(75) Inventors: Cheng-Wen Wu, Hsinchu City (TW); Chih-Tsun Huang, Hsinchu City (TW); Yu-Tsao Hsing, Pan Chiao City (TW)

Correspondence Address: John S. Egbert;Egbert Law Offices, 412 Main Street, 7th Floor, Houston, TX, 77002, US

(73) Assignee: NATIONAL TSING HUA UNIVERSITY, Hsinchu (TW)

(21) Appl. No.: 11/203,380

(22) Filed: Aug. 12, 2005

(30) Foreign Application Priority Data
May 4, 2005 (TW) 094114360

(51) Int. Cl. H04B 17/00

(52) U.S. Cl. 455/67.11; 455/73

(57) ABSTRACT

The present invention discloses a probing system for integrated circuit devices, which transmits testing data between an automatic test equipment (ATE) and an integrated circuit device. The ATE includes a first transceiving module, and the integrated circuit device includes a core circuit, a built-in self-test (BIST) circuit electrically connected to the core circuit, a controller configured to control the operation of the BIST circuit, and a second transceiving module configured to exchange testing data with the first transceiving module. Preferably, the integrated circuit device further includes a clock generator and a power regulator electrically connected to the second transceiving module, wherein the ATE transmits a radio frequency signal via the first transceiving module, and the second transceiving module receives the radio frequency signal to drive the power regulator to generate power for the integrated circuit device to initiate the BIST circuit.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a probing system for integrated circuit devices, and more particularly, to a probing system for integrated circuit devices in which testing data is transmitted in a wireless manner.

### BACKGROUND OF THE INVENTION

Generally speaking, before an integrated circuit device is packaged, a testing process is performed to check the electrical properties of the integrated circuit device on a wafer. The integrated circuit devices that meet the specifications of the electrical properties are selected for the subsequent packaging process, while others that do not meet the specifications are discarded to cut the packaging cost.

The conventional automatic test equipment (ATE) uses probe tips on a probe card to contact signal pads on a device under test (DUT) so as to form a path for transmitting the probing signal from the ATE to the DUT and transmitting the tested electrical parameters from the DUT to the ATE. However, the operation speed of the integrated circuit device such as the transistor increases continuously as semiconductor fabrication technology improves. The conventional technique uses the probe tip to mechanically probe the DUT and therefore its overall time accuracy (OTA) cannot catch up with the DUT with a highly improved operation speed. Consequently, the conventional ATE obviously cannot be used to probe the electrical property of the high-speed integrated circuit device in the future.

### BRIEF SUMMARY OF THE INVENTION

The objective of the present invention is to provide a probing system for integrated circuit devices, which can provide a better overall time accuracy for the application to the electrical testing of integrated circuit devices with a high operation speed.

In order to achieve the above-mentioned objective and avoid the problems of the prior art, the present invention provides a probing system for integrated circuit devices, which transmits testing data such as the probing signal and the tested electrical parameter between a testing machine including a first transceiving module and an integrated circuit device in a wireless manner. The integrated circuit device comprises a core circuit, a self-test circuit electrically connected to the core circuit, a controller configured to control the operation of the self-test circuit, and a second transceiving module configured to exchange testing data with the first transceiving module. Preferably, the integrated circuit device further comprises a clock generator electrically connected to the second transceiving module and a power regulator electrically connected to the second transceiving module, wherein the testing machine transmits a radio frequency signal by the first transceiving module and the second transceiving module receives the radio frequency signal to drive the power regulator to generate the operation power for the integrated circuit device.

The prior art uses a mechanical element, i.e., the tip, to transmit testing data, and therefore the overall time accuracy cannot catch up with the increasing high operation speed of integrated circuit devices. Conversely, the present probing system includes a transceiving module in the integrated circuit device to transmit testing data in a wireless manner; therefore the overall time accuracy is substantially the same as that of the integrated circuit device. In other words, the overall time accuracy of the present invention is not restricted by a mechanical element, and therefore can be applied to the electrical testing of integrated circuit devices with a high operation speed.

### BRIEF DESCRIPTION OF THE SEVERAL VIEWS OF THE DRAWINGS

The objectives and advantages of the present invention will become apparent upon reading the following description and upon reference to the accompanying drawings.

FIG. 1 is a schematic view of an illustration of a probing system for integrated circuit devices according to the first embodiment of the present invention.

FIG. 2 is another schematic view of an illustration of a probing system for integrated circuit devices according to the second embodiment of the present invention.

FIG. 3 is still another schematic view of an illustration of a probing system for integrated circuit devices according to the third embodiment of the present invention.

FIG. 4 is yet another schematic view of an illustration of a probing system for integrated circuit devices according to the fourth embodiment of the present invention.

### DETAILED DESCRIPTION OF THE INVENTION

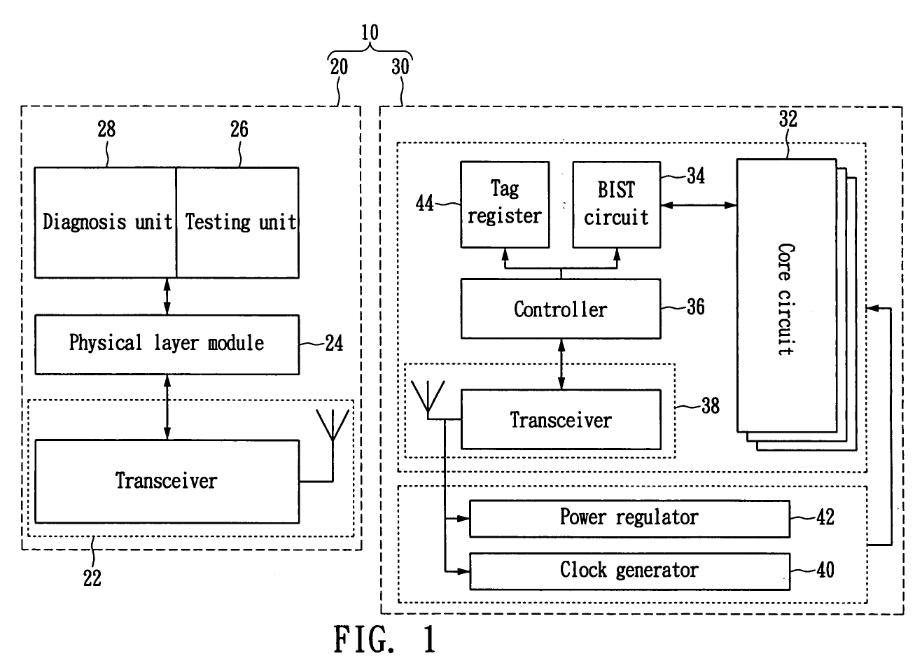

FIG. 1 illustrates a probing system 10 for integrated circuit devices according to the first embodiment of the present invention, in which testing data such as the probing signal and the tested electrical parameter is transmitted between a testing machine 20 and an integrated circuit device 30 in a wireless manner. The testing machine 20 comprises a first transceiving module 22, a physical layer module 24 electrically connected to the first transceiving module 22, a testing unit 26 electrically coupled to the physical layer module 24, and a diagnosis unit 28 electrically coupled to the physical layer module 24. The integrated circuit device 30 such as a system on chip (SOC) comprises a core circuit 32, a built-in self-test (BIST) circuit 34 electrically connected to the core circuit 32, a controller 36 configured to control the operation of the BIST circuit 34, and a second transceiving module 38 configured to exchange testing data with the first transceiving module 22. The first transceiving module 22 and the second transceiving module 32 each include a transceiver and an antenna.

The core circuit 32 can be a memory circuit, logic circuit, or analog circuit. In addition, the inventor of the present application filed two Taiwanese patent applications, No.088103352 and No. 090107845, disclosing the design technique of the BIST circuit 34. Preferably, the integrated circuit device 30 further comprises a clock generator 40 electrically connected to the second transceiving module 38 and a power regulator 42 electrically connected to the second transceiving module 38, wherein the testing machine 20 transmits a radio frequency signal by the first transceiving module 22 and the second transceiving module 32 receives the radio frequency signal to drive the power regulator 42 to generate the operation power for the integrated circuit device 30. Further, the integrated circuit device 30 may includes a tag register 44 for storing the identification of the integrated circuit device 30.

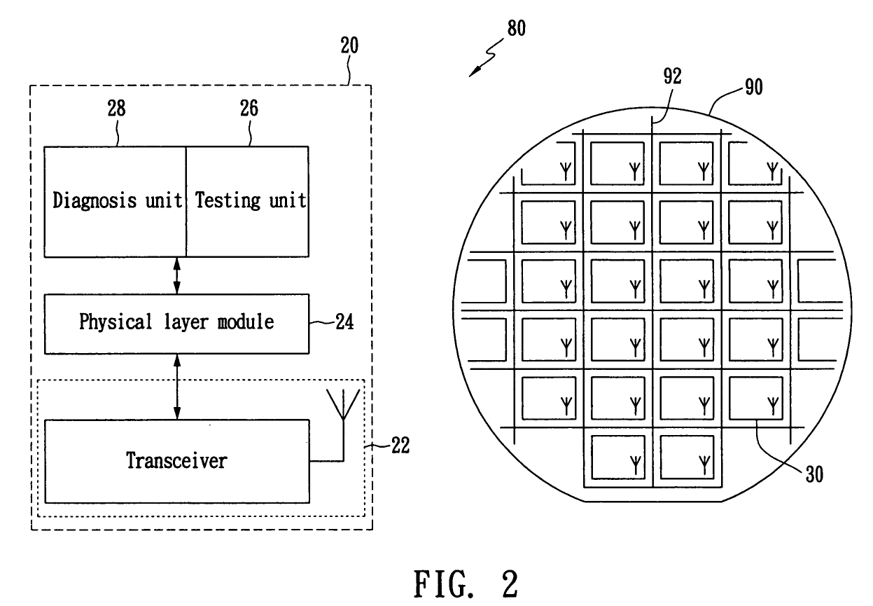

FIG. 2 illustrates a probing system 80 for integrated circuit devices according to the second embodiment of the present invention, which is applied to the electrical testing of a plurality of integrated circuit device 30 on a wafer. Particularly, the probing system 80 is applied to the electrical testing of the integrated circuit device 30 at a wafer level. During the electrical testing process, the testing machine 20 first transmits a radio frequency signal by the first transceiving module 22 and the second transceiving module 32 receives the radio frequency signal to drive the power regulator 42 to generate the operation power for the integrated circuit device 30. The testing unit 26 of the testing machine 20 sets an identification to each integrated circuit device 30 by the first transceiving module 22, and each integrated circuit device 30 stores its own identification in the tag register 44. Subsequently, the testing unit 26 transmits an activation instruction to the second transceiving module 32 to activate the BIST circuit 34 to perform the electrical testing of the core circuit 32. The diagnosis unit 28 accumulates testing data transmitted from each integrated circuit device 30 after the electrical testing is completed, and checks if the integrated circuit device 30 meets the specifications of the electrical properties and analyzes the failure cause of failed devices. In addition, the wafer 90 may include a power supply line 92 surrounding the integrated circuit device 30, and the integrated circuit device 30 can optionally acquire the operation power from the power supply line 92 rather than from the power generated by the power regulator 42 after receiving the radio frequency signal. Particularly, the power supply line 92 is positioned on the cutting lines of the wafer 90.

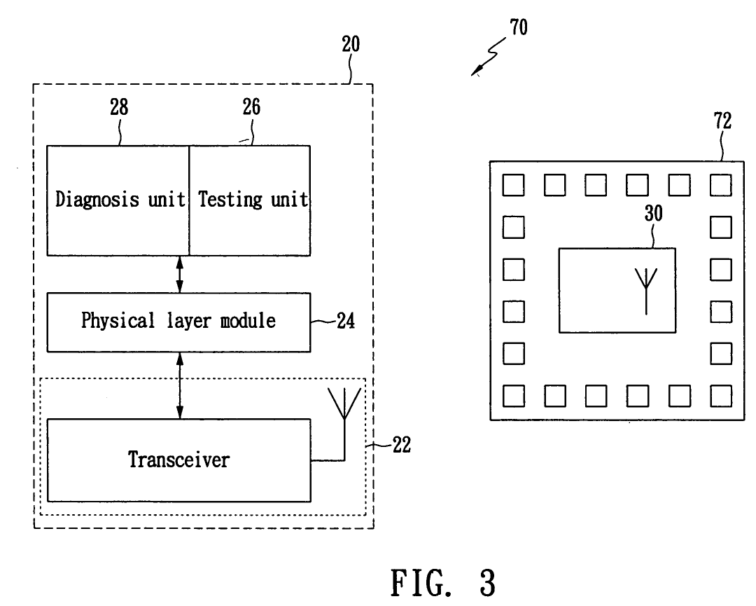

FIG. 3 illustrates a probing system 70 for integrated circuit devices according to the third embodiment of the present invention, which is applied to the final testing of an encapsulated die 72. As shown in FIG. 2, the wafer 90 is cut into a plurality of integrated circuit device 30, and those which meet electrical properties specifications are selected to perform the subsequent packaging process, while others that do not meet the specifications are discarded. The testing unit 26 transmits an activation instruction to the second transceiving module 32 to activate the BIST circuit 34 to perform the electrical testing of the core circuit 32, and the diagnosis unit 28 then accumulates testing data transmitted from each integrated circuit device 30 after the electrical testing is completed and checks if the integrated circuit device 30 meets the specifications of the electrical properties and analyzes the failure cause of any failed devices.

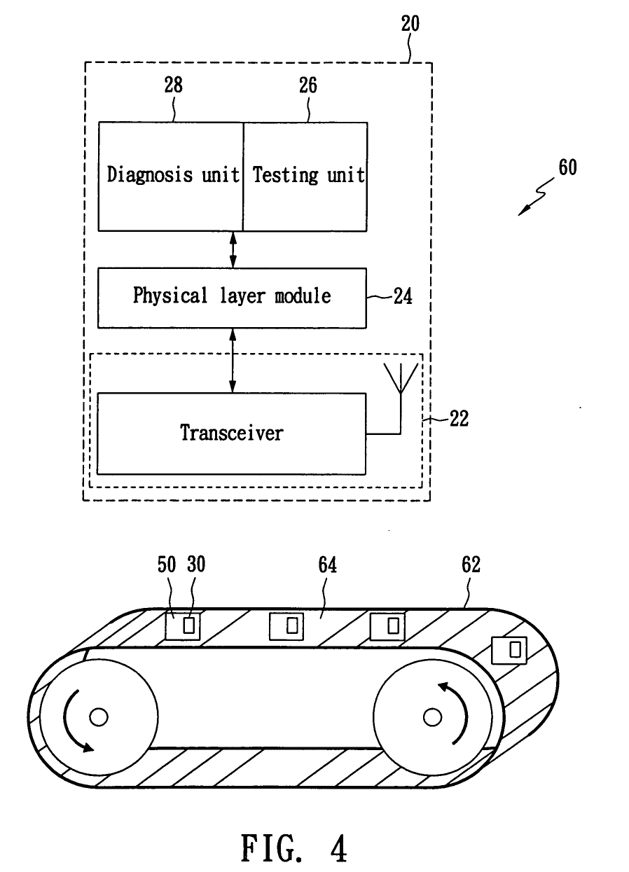

FIG. 4 illustrates a probing system 60 for integrated circuit devices according to the fourth embodiment of the present invention. The testing machine 20 further comprises a conveying device 62 electrically connected to a power supply. The integrated circuit device 30 is positioned on circuit board 50, which is electrically connected to the power supply via the conveying device 62, and the integrated circuit device 30 acquires the operation power from the circuit board 50, i.e., from the conveying device 62 via the circuit board 50. The conveying device 62 can convey the circuit board 50 with the integrated circuit device 30 to a predetermined position 64, where the testing unit 26 transmits an activation instruction to the second transceiving module 32 to activate the BIST circuit 34 to perform the electrical testing of the core circuit 32. Subsequently, the diagnosis unit 28 can accumulate testing data transmitted from each integrated circuit device 30 after the electrical testing is completed and checks if the integrated circuit device 30 meets the specifications of the electrical properties and analyze the failure cause of any failed devices.

The prior art uses a mechanical element, i.e., the tip, to transmit testing data, and therefore the overall time accuracy cannot catch up with the increasing operation speed of integrated circuit devices. Conversely, the present probing system includes a transceiving module in the integrated circuit device to transmit testing data in a wireless manner; therefore the overall time accuracy is substantially the same as that of the integrated circuit device. In other words, the overall time accuracy of the present invention is not restricted by mechanical elements, and therefore can be applied to the electrical testing of high-speed integrated circuit devices. Particularly, the present probing system for integrated circuit devices can diagnose the failure causes of a failed device in addition to performing electrical testing.

The above-described embodiments of the present invention are intended to be illustrative only. Numerous alternative embodiments may be devised by those skilled in the art without departing from the scope of the following claims.

We claim:

1. A probing system for integrated circuit devices, comprising:
a testing machine being comprised of a first transceiving module; and
an integrated circuit device under test, said integrated circuit device comprising:
a core circuit;
a self-test circuit electrically connected to the core circuit;
a controller configured to control operation of the self-test circuit; and
a second transceiving module configured to exchange data with the first transceiving module.

2. The probing system for integrated circuit devices of claim 1, wherein the integrated circuit device further comprises:
a clock generator electrically connected to the second transceiving module; and
a power regulator electrically connected to the second transceiving module,
wherein the testing machine transmits a radio frequency signal by the first transceiving module and the second transceiving module receives the radio frequency signal to drive the power regulator to generate the operation power for the integrated circuit device.

3. The probing system for integrated circuit devices of claim 1, wherein the integrated circuit device is positioned on a circuit board, and acquires the operation power from the circuit board.

4. The probing system for integrated circuit devices of claim 1, further comprising:
a conveying device, the integrated circuit device being transported to a predetermined position by the conveying device.

5. The probing system for integrated circuit devices of claim 4, wherein the conveying device is electrically connected to a power supply, and wherein the integrated circuit device acquires operation power from the conveying device.

6. The probing system for integrated circuit devices of claim 1, wherein the core circuit is comprised of a memory circuit, a logic circuit, or an analog circuit.

7. The probing system for integrated circuit devices of claim 1, wherein the testing machine further comprises:
a physical layer module electrically connected to the first transceiving module; and
a testing unit electrically coupled to the physical layer module.

8. The probing system for integrated circuit devices of claim 1, wherein the testing machine further comprises:
a physical layer module electrically connected to the first transceiving module; and
a diagnosis unit electrically coupled to the physical layer module.

9. The probing system for integrated circuit devices of claim 1, wherein the integrated circuit device further comprises:
a tag register for storing an identification of the integrated circuit device.

10. A probing system for integrated circuit devices, comprising:
a testing machine being comprised of a first transceiving module; and
a wafer having a plurality of integrated circuit devices and being comprised of:
a core circuit;
a tag register for storing an identification of the integrated circuit device;
a self-test circuit electrically connected to the core circuit;
a controller configured to control the operation of the core circuit; and
a second transceiving module configured to exchange data with the first transceiving module through a wireless communication.

11. The probing system for integrated circuit devices of claim 10, wherein the wafer further comprises a power supply line surrounding the integrated circuit device, and wherein the integrated circuit device acquires operation power from the power supply line.

12. The probing system for integrated circuit devices of claim 11, wherein the power supply line is positioned on a cutting line of the wafer.

13. The probing system for integrated circuit devices of claim 10, wherein the integrated circuit device further comprises:
a clock generator electrically connected to the second transceiving module; and
a power regulator electrically connected to the second transceiving module,
wherein the testing machine transmits a radio frequency signal by the first transceiving module and the second transceiving module receives the radio frequency signal to drive the power regulator to generate the operation power for the integrated circuit device.

14. The probing system for integrated circuit devices of claim 10, wherein the core circuit is comprised of a memory circuit, a logic circuit, or an analog circuit.

15. The probing system for integrated circuit devices of claim 10, wherein the testing machine further comprises:
a physical layer module electrically connected to the first transceiving module; and
a testing unit electrically coupled to the physical layer module.

16. The probing system for integrated circuit devices of claim 10, wherein the testing machine further comprises:
a physical layer module electrically connected to the first transceiving module; and
a diagnosis unit electrically coupled to the physical layer module.
